(19) United States
(12) Patent Application Publication
(10) Pub. No.: US 2010/0195056 A1
(43) Pub. Date: Aug. 5, 2010

(54) HYBRID POLARIZATION BEAM SPLITTER ARCHITECTURE AND OPTICAL PROJECTION SYSTEM THEREOF

(76) Inventors: Jinn-Chou Yoo, Tainan County (TW); Chun-Min Chen, Tainan County (TW)

Correspondence Address: NORTH AMERICA INTELLECTUAL PROPERTY CORPORATION, P.O. BOX 506, MERRIFIELD, VA, 22116, US

(21) Appl. No.: 12/366,608

(22) Filed: Feb. 5, 2009

(51) Int. Cl. G02B 27/28; G03B 21/14

(52) U.S. Cl. 353/20; 359/485

(57) ABSTRACT

A hybrid PBS architecture includes a first prism, a second prism, and a beam splitting coating layer. The first prism is made of a first material, and the second prism is made of a second material being different from the first material. The beam splitting coating layer is sandwiched between the first prism and the second prism. The first material is a glass material and the second material is a plastic material.

### BACKGROUND OF THE INVENTION

1. Field of the Invention

The present invention relates to a polarization beam splitter (PBS) architecture and a related optical projection system, and more particularly, to a hybrid PBS architecture and a related optical projection system by adopting two different materials (such as glass and plastic material) to improve light efficiency and to reduce the whole size and cost.

2. Description of the Prior Art

As technology advances, large screen and high quality projectors and projection televisions are gaining in popularity for satisfying the demands of consumers. Today, almost all projectors and projection televisions are installed with complex optical projection systems using the latest manufacture technology available.

One of the most common components appearing in the optical projection system is a polarization beam splitter (PBS) prism. Nowadays, the PBS prism is usually made of a glass material. This kind of PBS prism has an advantage of low birefringence, but it has low plasticity. Thus, another PBS prism made of a plastic material is used for replacing the PBS prism made of the glass material. The PBS prism made of a plastic material is capable of forming any shape or any non-spherical surface directly, but its birefringence is not good enough.

Hence, how to overcome such drawbacks and how to reduce cost become an important topic of the field.

### SUMMARY OF THE INVENTION

It is one of the objectives of the claimed invention to provide a hybrid PBS architecture and a related optical projection system to solve the above-mentioned problems.

According to an exemplary embodiment of the present invention, a hybrid PBS architecture is provided. The hybrid PBS architecture includes a first prism, a second prism, and a beam splitting coating layer. The first prism is made of a first material, and the second prism is made of a second material being different from the first material. The beam splitting coating layer is sandwiched between the first prism and the second prism. The first material is a glass material and the second material is a plastic material.

According to an exemplary embodiment of the present invention, an optical projection system is provided. The optical projection system includes a hybrid PBS architecture and an imager. The hybrid PBS architecture includes a first prism, a second prism, and a beam splitting coating layer. The first prism is made of a first material, and the second prism is made of a second material being different from the first material. The beam splitting coating layer is sandwiched between the first prism and the second prism. The first material is a glass material and the second material is a plastic material. The imager is disposed near the first prism of the hybrid PBS architecture for displaying images.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a diagram of a hybrid PBS architecture according to a first embodiment of the present invention.

FIG. 2 is a diagram of a hybrid PBS architecture according to a second embodiment of the present invention.

FIG. 3 is a diagram of an optical projection system according to an embodiment of the present invention.

### DETAILED DESCRIPTION

Certain terms are used throughout the following description and claims to refer to particular components. As one skilled in the art will appreciate, hardware manufacturers may refer to a component by different names. This document does not intend to distinguish between components that differ in name but in function. In the following discussion and in the claims, the terms “include”, “including”, “comprise”, and “comprising” are used in an open-ended fashion, and thus should be interpreted to mean “including, but not limited to . . . ”. The terms “couple” and “coupled” are intended to mean either an indirect or a direct electrical connection. Thus, if a first device couples to a second device, that connection may be through a direct electrical connection, or through an indirect electrical connection via other devices and connections.

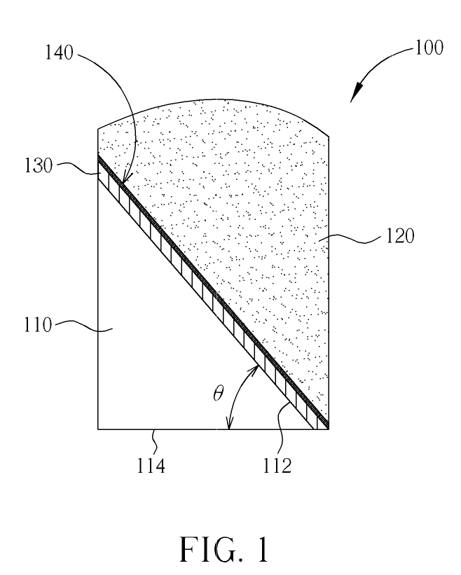

Please refer to FIG. 1. FIG. 1 is a diagram of a hybrid PBS architecture 100 according to a first embodiment of the present invention. As shown in FIG. 1, the hybrid PBS architecture 100 includes (but is not limited to) a first prism 110, a second prism 120, and a beam splitting coating layer 130. The first prism 110 is made of a first material, and the second prism 120 is made of a second material being different from the first material. In one embodiment, the first material is a glass material, and the second material is a plastic material. The beam splitting coating layer 130 is sandwiched between the first prism 110 and the second prism 120. Furthermore, in order to protect the beam splitting coating layer 130 from a crack resulted from different thermal expansion coefficients of the first prism 110 and the second prism 120, an optical oil 140 can be spread on the beam splitting coating layer 130.

Because the first prism 110 is made of a glass material and the second prism 120 is made of a plastic material, the hybrid PBS architecture 100 disclosed in the present invention can possess the aforementioned advantages of both, i.e. the low birefringence and good plasticity.

Please note that the hybrid PBS architecture 100 can be disposed in an optical projection system, but this should not be considered as a limitation of the present invention. In addition, as shown in FIG. 1, the first prism 110 has a hypotenuse surface 112 contacting the beam splitting coating layer 130 and a base surface 114, and an angle θ between the hypotenuse surface 112 and base surface 114 is not limited to 45 degrees. In other words, the optical projection system adopting the hybrid PBS architecture 100 is suitable for non-axis or asymmetric systems.

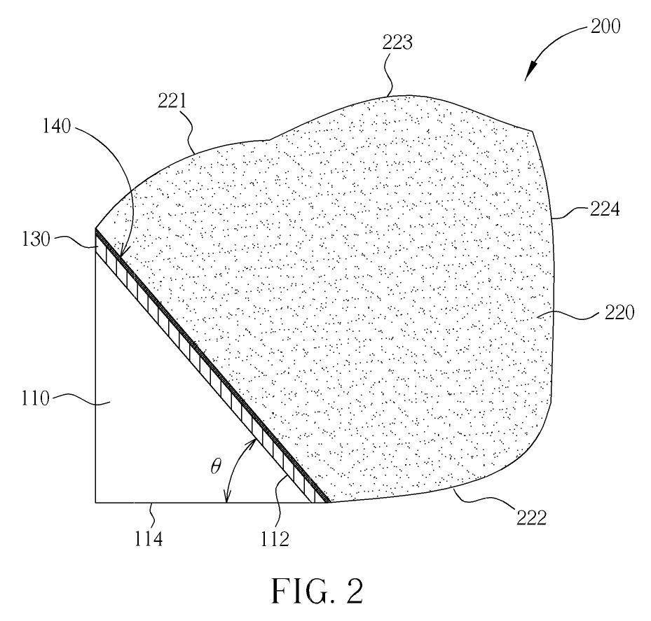

Please note that again, the second prism 120 of the hybrid PBS architecture 100 can have at least one (or can be two or more) curved surface acting as a reflector or a projection lens, and those skilled in the art should know that this is not a limitation of the present invention. Therefore, the optical projection system with a modulization design can be achieved. Please refer to FIG. 2. FIG. 2 is a diagram of a hybrid PBS architecture 200 according to a second embodiment of the present invention, which is a varied embodiment of the hybrid PBS architecture 100 shown in FIG. 1. In FIG. 2, the hybrid PBS architecture 200 is similar to the hybrid PBS architecture 100 shown in FIG. 1, and the difference between them is that a second prism 220 of the hybrid PBS architecture 200 has several curved surfaces 221, 222, 223, and 224 respectively acting as a reflector or a projection lens. For example, the curved surfaces 221 and 222 respectively act as a reflector. The curved surfaces 223 and 224 respectively act as an output lens and a projection lens. Those skilled in the art should appreciate that the number and the purpose of the curved surfaces are not limited. Due to the second prism 220 being capable of forming several curved surfaces to replace external projection lenses, the number of external projection lenses can be reduced to achieve a modulization design.

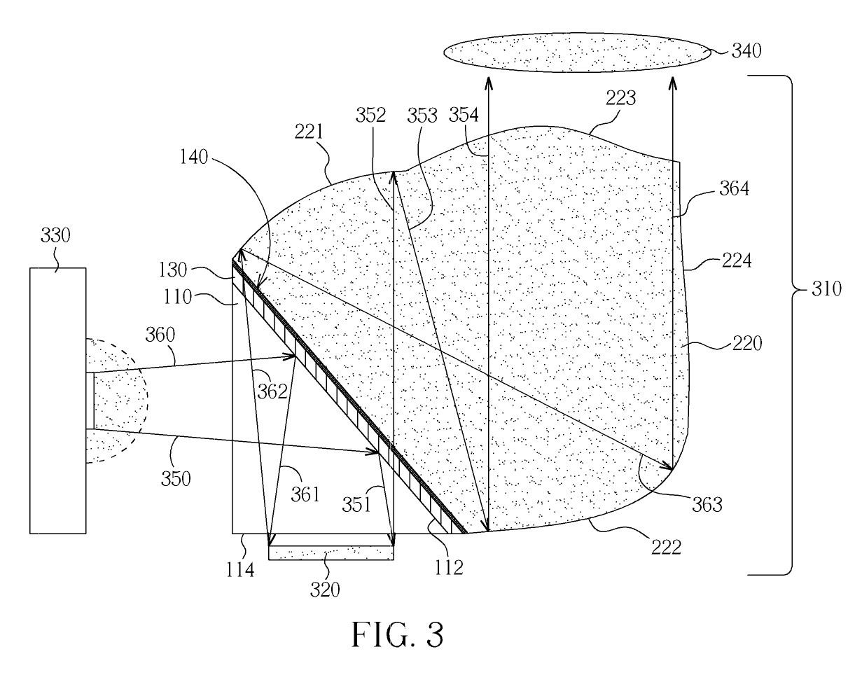

Please refer to FIG. 3. FIG. 3 is a diagram of an optical projection system 300 according to an embodiment of the present invention. The optical projection system 300 includes a hybrid PBS architecture 310, an imager 320, a light source 330, and an extra projection lens 340. In this embodiment, the hybrid PBS architecture 310 is the same as the hybrid PBS architecture 200 shown in FIG. 2. The imager 320 is disposed near the first prism 110 of the hybrid PBS architecture 310 for displaying images. The light source 330 is used for generating input light beams 350 and 360 to the hybrid PBS architecture 310. In the following description, some examples are taken to illustrate the path of the input light beams 350 and 360.

In a first example, the input light beam 350 is sent to the beam splitting coating layer 130 through the first prism 110 to generate a first reflected light beam 351 to the imager 320, the first reflected light beam 351 is modulated by the imager 320 to generate a second reflected light beam 352 to pass through the beam splitting coating layer 130 to the second prism 220, the second reflected light beam 352 is reflected by the curved surface 221 to generate a third reflected light beam 353, and the third reflected light beam 353 is reflected by the curved surface 222 to generate a fourth light beam 354. Finally, the fourth reflected light beam 354 is outputted from the curved surface 223 to the extra projection lens 340, and the extra projection lens 340 then projects an image of the fourth reflected light beam 354.

Similarly, in a second example, the input light beam 360 is sent to the beam splitting coating layer 130 through the first prism 110 to generate a first reflected light beam 361 to the imager 320, the first reflected light beam 361 is modulated by the imager 320 to generate a second reflected light beam 362 to pass through the beam splitting coating layer 130 to the second prism 220, the second reflected light beam 362 is reflected by the curved surface 221 to generate a third reflected light beam 363, and the third reflected light beam 363 is reflected by the curved surface 222 to generate a fourth light beam 364. Finally, the fourth reflected light beam 364 is outputted from the curved surface 223 to the extra projection lens 340, and the extra projection lens 340 then projects an image of the fourth reflected light beam 364.

As can be seen from FIG. 3, due to the first prism 110 (made of a glass material) having low birefringence, the first reflected light beams 351 and 361 will not be seriously affected by birefringence effect to worsen the performance (such as contrast or uniformity) of the whole system. In addition, due to the second prism 220 (made of a plastic material) having good plasticity, several curved surfaces can be formed on the second prism 220 to replace external projection lens and thereby achieve a modulization design. Therefore, not only the size of the optical projection system 300 can be reduced, but also the cost can be lowered.

Please note that the extra projection lens 340 can be collocated with the hybrid PBS architecture 310 disclosed in the present invention to improve the projected image quality. For example, the extra projection lens 340 can be calibrated to provide focusing or zooming functions.

The abovementioned embodiments are presented merely for describing the present invention, and in no way should be considered to be limitations of the scope of the present invention. In summary, the present invention provides a hybrid PBS architecture and a related optical projection system. By adopting both the glass material and the plastic material to constitute the hybrid PBS architecture, the hybrid PBS architecture 100 disclosed in the present invention can possess the advantages of both, i.e. the low birefringence and good plasticity. In addition, because the second prism 220 is capable of forming several curved surfaces to replace external projection lens, the number of external projection lenses can be reduced to achieve a modulization design. Therefore, not only the size of the optical projection system 300 can be reduced, but also the cost can be lowered. Furthermore, the extra projection lens 340 can be collocated with the hybrid PBS architecture 310 disclosed in the present invention to improve the projected image quality.

Those skilled in the art will readily observe that numerous modifications and alterations of the device and method may be made while retaining the teachings of the invention.

What is claimed is:

1. A hybrid polarization beam splitter (PBS) architecture, comprising:
a first prism, made of a first material;
a second prism, made of a second material being different from the first material; and
a beam splitting coating layer, sandwiched between the first prism and the second prism.

2. The hybrid PBS architecture of claim 1, wherein the first material is a glass material, and the second material is a plastic material.

3. The hybrid PBS architecture of claim 2, wherein the second prism has a curved surface acting as a reflector.

4. The hybrid PBS architecture of claim 2, wherein the second prism has a curved surface acting as a projection lens.

5. The hybrid PBS architecture of claim 2, further comprising:
an optical oil, spread on the beam splitting coating layer.

6. The hybrid PBS architecture of claim 1, being disposed in an optical projection system.

7. The hybrid PBS architecture of claim 6, wherein the optical projection system is non-axis or asymmetric.

8. An optical projection system, comprising:
a hybrid PBS architecture, comprising:
a first prism, made of a first material;
a second prism, made of a second material being different from the first material; and
a beam splitting coating layer, sandwiched between the first prism and the second prism; and
an imager, disposed near the first prism of the hybrid PBS architecture, for displaying images.

9. The optical projection system of claim 8, wherein the first material is a glass material, and the second material is a plastic material.

10. The optical projection system of claim 9, wherein the second prism has a curved surface acting as a reflector.

11. The optical projection system of claim 9, wherein the second prism has a curved surface acting as a projection lens.

12. The optical projection system of claim 9, further comprising:
an optical oil, spread on the beam splitting coating layer.

13. The optical projection system of claim 8, being non-axis or asymmetric.
